(19) United States
(12) Patent Application Publication
(10) Pub. No.: US 2026/0298025 A1
(43) Pub. Date: Oct. 1, 2026

(54) KITCHEN HELPER FOLDING STEP STOOL WITH SPRING LOADED CROSSBAR RETAINER

(71) Applicant: Dorel Home Furnishings, Inc., Wright City, MI (US)

(72) Inventors: Jason A. Boyer, Columbus, IN (US); Kyle J. Lawrence, Greenfield, IN (US)

(21) Appl. No.: 19/692,819

(22) Filed: May 29, 2026

Related U.S. Application Data
(63) Continuation-in-part of application No. 19/353,175, filed on Oct. 8, 2025.
Application No. 19/353,175 is a continuation-in-part of application No. 17/339,258, filed on Jun. 4, 2021, now Pat. No. 12,453,423.
(60) Provisional application No. 63/034,718, filed on Jun. 4, 2020.
(60) Provisional application No. 63/815,316, filed on May 30, 2025.
(60) Provisional application No. 63/884,881, filed on Sep. 19, 2025.

(51) Int. Cl. E06C 1/393; E06C 7/18

(52) U.S. Cl. CPC E06C 1/393; E06C 7/182; E06C 7/185

(57) ABSTRACT

The present disclosure relates to a step stool, and particularly to a foldable step stool. More particularly, the present disclosure relates to a foldable step stool that has a crossbar adapted to help a user standing on the step stool.

### PRIORITY CLAIM

This application is a continuation-in-part of U.S. application Ser. No. 19/353,175, filed Oct. 8, 2025, which is itself a continuation-in-part of U.S. application Ser. No. 17/339,258, filed Jun. 4, 2021, which claimed priority under 35 U.S.C. § 119 (e) to U.S. Provisional Application Ser. No. 63/034,718, filed Jun. 4, 2020; this application further claims priority under 35 U.S.C. § 119 (e) to U.S. Provisional Application 63/815,316, filed May 30, 2025, and to U.S. Provisional Application 63/884,881, filed Sep. 19, 2025; all above noted priority applications are expressly incorporated by reference herein.

### BACKGROUND

The present disclosure relates to a step stool, and particularly to a foldable step stool. More particularly, the present disclosure relates to a foldable step stool that can be collapsed to save storage space when the foldable step stool is not in use.

### SUMMARY

A foldable step stool according to the present disclosure is movable from an expanded use position to a collapsed storage position. In the expanded use position, a platform panel is supported above the ground in a first horizontal plane so that a user may stand on the platform panel. In the collapsed storage position, platform panel is moved out of the first horizontal plane to reduce the footprint of the foldable step stool and save space when the foldable step stool is not in use.

In illustrative embodiments, the foldable step stool includes a step unit with rear legs and a lower step, a step unit stabilizer with front legs, and a platform unit with the platform step panel being supported by the rear legs and the front legs when the foldable step stool is in the expanded use position. The step unit stabilizer may also include a three-sided platform surround rail that is above the platform panel in a second horizontal plane so that a user may be surrounded on three sides when standing on the platform panel. The three-sided platform surround rail includes a front handle portion that extends along a front side edge of the platform panel and side portions that extend along side edges of the platform panel.

In illustrative embodiments, the foldable step stool may further include a rear crossbar movable from an entry position extending along one of the rear legs of the step unit to a horizontal safe position extending between the rear legs of the step unit along a rear side edge of the platform panel. When in the horizontal safe position, the rear crossbar cooperates with the three-sided platform surround rail so that a user may be surrounded on all four sides when standing on the platform panel.

In illustrative embodiments, the foldable step stool may also include a crossbar latch to selectively retain the crossbar in either the entry position or the horizontal safe position. The crossbar latch can include a sliding latch catch that blocks movement away from the established entry and/or horizontal positions. In some embodiments, the crossbar latch is adapted to be added to the crossbar in an aftermarket way. In other embodiments, the crossbar latch can be integrated into the crossbar at initial manufacture of the foldable step stool.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a foldable step stool with top platform unit, a u-shaped handle rail supported over the top platform unit, and a crossbar that pivots from a horizontal safe position to a downwardly-extending entry position;

FIG. 2 is a detail view of a portion of the foldable step stool of FIG. 1 showing a crossbar latch fixed to the crossbar and configured to selectively allow the crossbar to disengage from a frame of the step stool and move from the horizontal safe position to the downwardly-extending entry position;

FIG. 3 is a perspective view of the crossbar retainer from FIGS. 1 and 2 along with other portions of the foldable step stool showing that the crossbar latch includes a housing with a body that forms a bar-receiving channel sized to receive a portion of the crossbar, a fixation plate adapted to be coupled to the body so as to trap the crossbar in the bar-receiving channel, and a latch catch mounted to slide relative to the housing from a normally extended, locked position to a retracted, unlocked position as suggested in FIGS. 4-6;

FIG. 4 is a detail perspective view of the crossbar and the crossbar retainer when the crossbar is in the horizontal position and the crossbar latch is in the locked position to block the crossbar from movement to the entry position;

FIG. 5 is a detail perspective view of the crossbar and the crossbar retainer when the crossbar is in the horizontal position and the crossbar latch is moved to the unlocked position via sliding of the latch catch to allow the crossbar to move to the entry position;

FIG. 6 is a detail perspective view of the crossbar and the crossbar latch when the crossbar is in the entry position after the unlocked crossbar latch allowed motion away from the horizontal position;

FIG. 7 is a perspective view of a second embodiment of a foldable step stool in accordance with the present disclosure showing that the foldable step stool includes a crossbar and an integrated crossbar latch;

FIG. 8 is a detail view of a portion of the foldable step stool in FIG. 7 showing the crossbar in a horizontal safe position and the crossbar latch in the locked position to block the crossbar from movement;

FIG. 9 is a detail view of a portion of the foldable step stool in FIG. 7 showing the crossbar in the horizontal safe position and the crossbar latch moved to the unlocked position to allow the crossbar to move as suggested in FIG. 10; and

FIG. 10 is a detail view of a portion of the foldable step stool in FIG. 7 showing the crossbar moving away from the horizontal safe position while the crossbar latch in the unlocked position.

### DETAILED DESCRIPTION

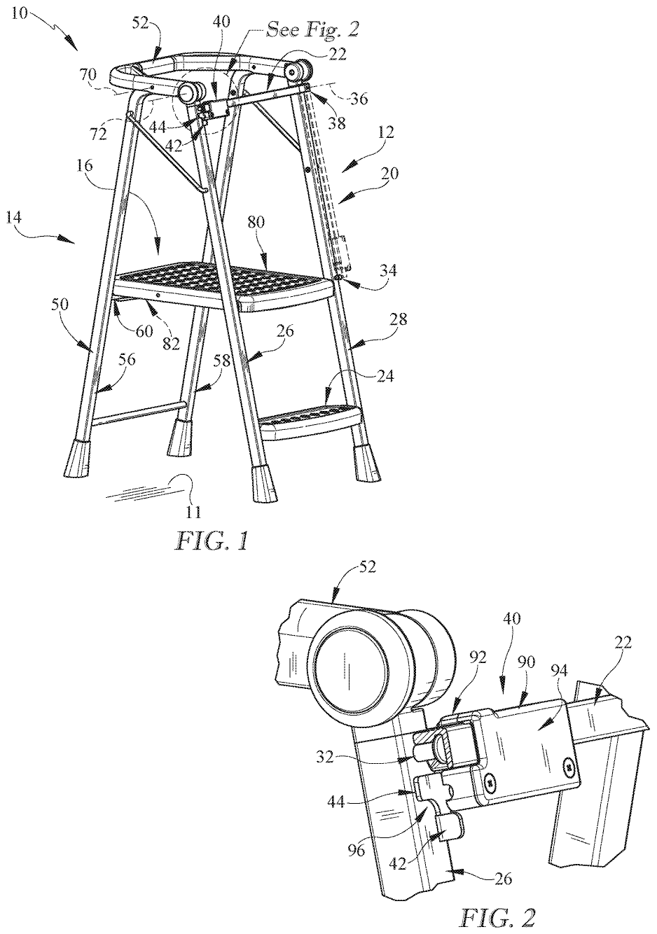

A foldable step stool 10 provides support for a user above ground 11 as suggested in FIG. 1. The foldable step stool 10 is reconfigurable from an expanded use configuration to a collapsed storage position. The expanded use configuration is shown in FIG. 1 and provides a platform step panel 80 in a horizontal orientation to support a user in an elevated position above the ground 11. In the collapsed storage position the platform step panel 80 is moved along with other components of the foldable step stool 10 to reduce the footprint of the foldable step stool 10 to save space when the foldable step stool is not in use.

The foldable step stool 10 provides a stable structure with parallelogram shape formed by a front frame 50, a rear frame 20, and a u-shaped handle rail 52 as shown in FIG. 1. The platform step panel 80 is supported by a platform support bar 60 on the front frame 50 and a pivotable bar 30 on the rear frame 20.

The foldable step stool illustratively includes a step unit 12, a stabilizer unit 14, and a top platform unit 16 as shown in FIG. 1. The top platform unit 16 is supported above the ground 11 by the step unit 12 and the stabilizer unit 14 when the foldable step stool 10 in the expanded use configuration. The top platform unit 16 is pivotably coupled to the step unit 12. The step unit 12 is pivotably coupled to the stabilizer unit 14 at a top end of the step unit 12 and located aft of the stabilizer unit 14 when the foldable step stool is in the expandable use configuration and positioned near a kitchen counter or similar elevated surface.

The step unit 12 includes the rear frame 20 and a rear pivoting crossbar 22 that pivotably couples to the rear frame 20 as shown in FIG. 1. The rear frame 20 provides the entry path to the foldable step stool and includes a lower short step 24, a left rear leg 26, a right rear leg 28, and a pivotable bar 30 as shown in FIG. 2. The pivotable bar 30 and the lower short step 24 interconnect the left rear leg 26 and the right rear leg 28 together.

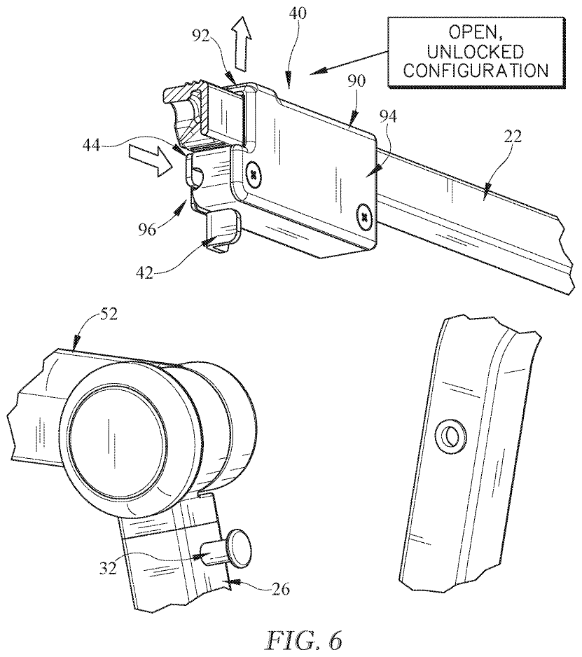

The left rear leg 26 is pivotably coupled to the stabilizer unit 14 at the top of the leg and includes a foot at the base of the leg that engages the ground 11 as shown in FIG. 2. The left rear leg 26 further includes a crossbar latch pin 32 a small distance from the top of the leg. The crossbar latch pin 32 extends rearwards and perpendicular from the left rear leg 26 as shown in FIGS. 2-6. The crossbar latch pin 32 provides an attaching point for the rear pivoting crossbar 22 when the rear pivoting crossbar 22 is in the horizontal safe position. In some embodiments, the crossbar latch pin 32 may also provide riveting functions to couple a pivoting member to the top of the left rear leg 26.

The rear pivoting crossbar 22 is pivotably coupled to the rear frame 20 and is reconfigurable between a horizontal safe position and an entry position as shown in FIG. 1. The rear pivoting crossbar 22 includes a pivoting pin 38 at one end and a crossbar latch 40 at the opposite end. The pivoting pin 38 is coupled to the right rear leg 28 a small distance from the top of the right rear leg 28. The pivoting pin 38 allows the rear pivoting crossbar 22 to pivot around a crossbar axis 36 that extends through the pivoting pin 38 and the right rear leg 28.

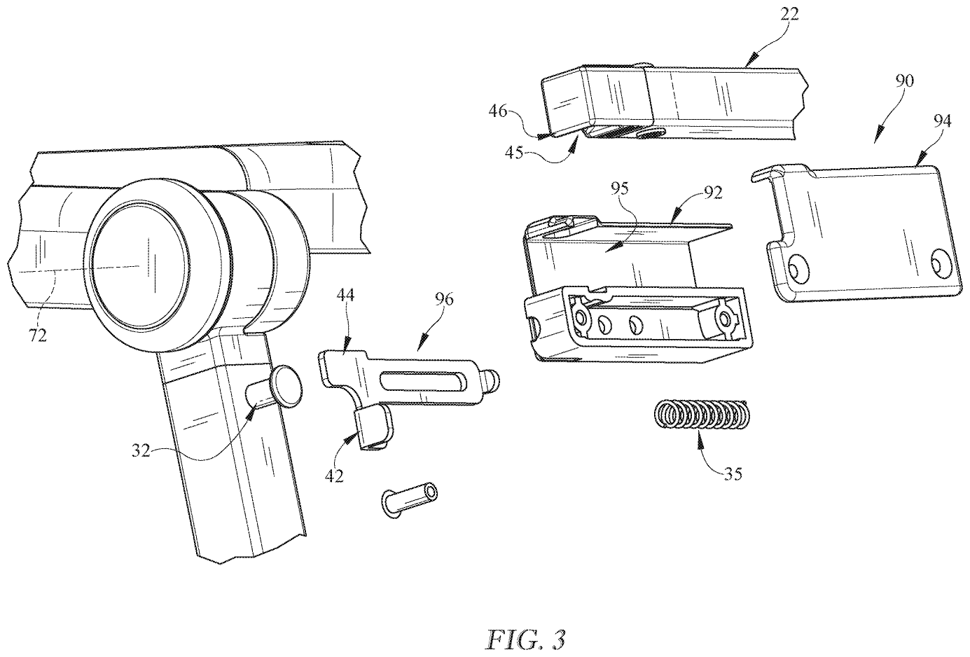

The crossbar latch 40 includes a latch button 42, a latch catch 44, and a latch slot 46 as shown in FIGS. 3-6. The latch button 42 is directly connected to the latch catch 44 to move therewith, and the latch button 42 is slidably mounted to the rear pivoting crossbar 22. The latch slot 46 forms a downwardly-opening space 45 in the rear pivoting crossbar 22 that slidably receives one of the crossbar latch pin 32 or the crossbar storage latch pin 34. In the illustrated embodiment, the latch slot 46 is arranged at a distal, free end of the crossbar 22 opposite the pivot pin 38. The latch catch 44 extends across the bottom of the latch slot 46 when the crossbar is in the horizontal position to couple the rear pivoting crossbar 22 to the crossbar latch pin 32. The crossbar latch 40 can also be fixed to a crossbar storage latch pin 34.

When a user slides the latch button 42 towards the pivoting pin 38, the latch catch 44 moves with the latch button 42 towards the pivoting pin 38 into an entry position that opens the latch slot 46 so that the rear pivoting crossbar 22 can be slidably detached from one of the crossbar latch pin 32 or the crossbar storage latch pin 34. The latch button 42 and latch catch 44 is biased to the horizontal position with a spring 35.

The crossbar latch 40 allows the rear pivoting crossbar 22 to detachably couple to the crossbar latch pin 32 when the rear pivoting crossbar 22 is in the horizontal safe position. The crossbar latch 40 also allows the rear pivoting crossbar 22 to detach from the crossbar storage latch pin 34 when the rear pivoting crossbar 22 moves to the unlocked position. In the horizontal safe position, the rear pivoting crossbar 22 extends horizontally between the pivoting pin 38 located on the right rear leg 28 to the crossbar latch pin 32 located on the left rear leg 26. In the horizontal safe position, the rear pivoting crossbar 22 prevents a user standing on the platform unit 16 from falling backwards and off the foldable step stool 10 as shown in FIG. 1. In the entry position, the rear pivoting crossbar 22 is in parallel alignment with the right rear leg 28, and allows a user to step on to or step off the platform unit 16.

In the illustrative embodiment, the crossbar latch 40 further includes a housing 90 suitable for aftermarket coupling to the crossbar 22 as shown in FIGS. 1-3. The housing 90 includes a body 92 and a fixation plate 94. The body 92 forms a bar-receiving channel 95 that receives a portion of the crossbar 22. The fixation plate 94 is coupled to the body 92 via fasteners and is shaped to close the bar-receiving channel 95 trapping the crossbar 22 therein. The housing 90 is coupled to a portion of the crossbar 22 spaced apart from a free, distal end of the crossbar 22 such that it is located between the opening 45 and the proximal end of the crossbar at which the crossbar is mounted for movement relative to the u-shape handle rail about the pivot pin 38.

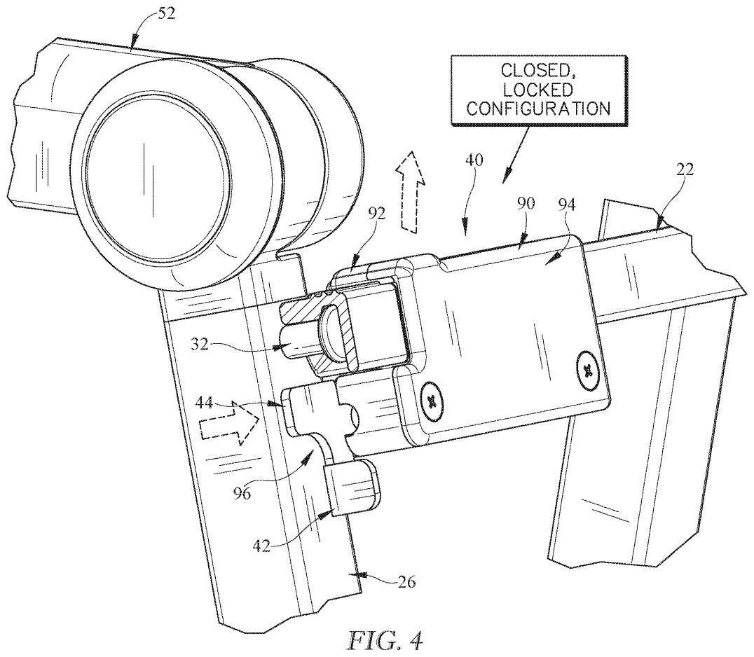

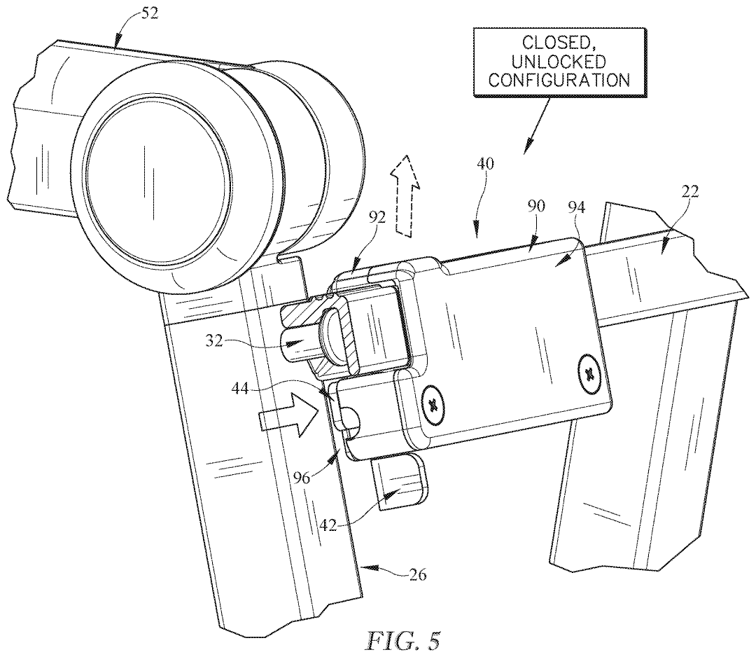

In the illustrative embodiment, the latch button 42 and the latch catch 44 are made from a one-piece monolithic keeper component 96 as shown in FIG. 3. The latch button 42 extends out from housing 90 so that it can be manipulated by a user. The latch catch 44 moves from a normally extended position associated with the locked position of the crossbar latch 40, shown in FIG. 4, to a retracted position associated with the unlocked position of the crossbar latch 40, shown in FIG. 5.

In the extended position, the latch catch 44 extends under the opening 45 to block movement of the crossbar 22 from the horizontal safe position to the entry position. In the retracted position, the latch catch 44 is moved out of the way and allows the crossbar 22 to be lifted up and away from the latch pin 34. A spring 35 provides a biasing member that pushes the keeper component toward the extended position.

The stabilizer unit 14 collaborates with the step unit 12 to stabilize the foldable step stool 10 when the foldable step stool 10 is in the expanded use configuration as shown in FIG. 1. The stabilizer unit 14 includes the front frame 50, and the u-shaped handle rail 52, as shown in FIG. 1. The front frame 50 is pivotably coupled about a front leg axis 70 to the u-shaped handle rail 52, and the u-shaped handle rail 52 is further pivotably coupled about a rear leg axis 72 to the rear frame 20.

The front frame 50 is located forward of the rear frame 20 and will typically be positioned adjacent to a kitchen counter or similar. The front frame 50 includes a left front leg 56, a right front leg 58, and a platform support bar 60 as shown in FIG. 1. The platform support bar 60 interconnects the left front leg 56 and the right front leg 58 together and provides support to the platform unit 16. The distance between the ground 11 and the platform support bar 60 corresponds to the selected height of the platform unit 16. The platform support bar 60 of the front frame 50 and the pivotable bar 30 of the rear frame 20 are positioned relative to the ground 11 so that the platform unit 16 has horizontal orientation in the expanded use configuration. The platform support bar 60 further couples with the platform latch 82 of the platform unit 16 to lock the foldable step stool 10 in the expanded use position when the platform latch 82 engages the platform support bar 60.

The left front leg 56 and the right front leg 58 are pivotably coupled about the front leg axis 70 to the u-shaped handle rail 52 at the top of the legs as shown in FIG. 1. The left front leg 56 and the right front leg 58 each includes a foot at the base of the leg that engages the ground 11.

The U-shaped handle rail 52 is located at the top of the foldable step stool 10 and provides a stabilizing handle for a user to balance themselves when stood on the platform unit 16 and prevents a user from falling forward or sideways off the foldable step stool 10. The u-shaped handle rail 52 has a U-shape that is open on the aft side of the foldable step stool 10 so that a user can freely step into the foldable step stool 10 and be positioned centrally in the U-shaped handle rail 52. The U-shaped handle rail 52 has horizontal orientation when the foldable step stool 10 is in the expanded use configuration. The foldable step stool 10 is sized so that in the expanded use configuration, the U-shaped handle rail 52 is a similar distance from the ground 11 as a typical kitchen counter or table.

The platform unit 16 provides a stable horizontal surface for the user to stand on when the foldable step stool 10 is in the expanded use configuration as shown in FIG. 1. The platform unit 16 includes the platform step panel 80 pivotably coupled to the pivotable bar 30 of the rear frame 20 and detachably coupled to the platform support bar 60 of the front frame 50. The platform step panel 80 provides a rigid surface for a user to stand on and is sized so that a user has adequate space for standing securely.

The platform step panel 80 is positioned on the foldable step stool 10 at a height above the ground 11 so that a user can reach a kitchen counter or similar elevated surface when stood on the platform step panel 80.

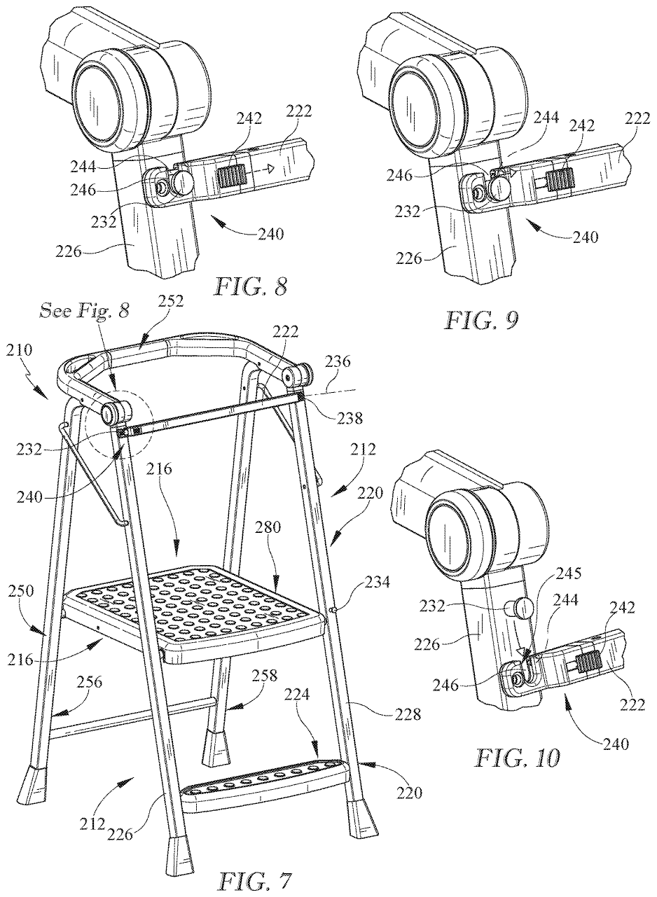

A second embodiment of a foldable step stool 210 is shown in FIGS. 7-10. The foldable step stool 210 is substantially similar to step stool 10 described herein and shown in FIGS. 1-6. Accordingly, the disclosure of step stool 10 is incorporated herein in its entirety for step stool 210 except for differences described in this specification and shown in FIGS. 7-10. Such differences include a crossbar latch 240 that is integrated with the crossbar 222 as illustrated in FIGS. 8-10.

The crossbar latch 240 includes a latch button 242, a latch catch 244, and a latch slot 246 as shown in FIGS. 8-10. The latch button 242 is directly connected to the latch catch 244 to move therewith, and the latch button 242 is slidably mounted to the rear pivoting crossbar 222. The latch slot 246 forms an upwardly-opening space 245 in the rear pivoting crossbar 222 that slidably receives one of the crossbar latch pin 32 or the crossbar storage latch pin 234. In the illustrated embodiment, the latch slot 246 is arranged at a distal, free end of the crossbar 222 opposite the pivot pin 238. The latch catch 244 extends across the top of the latch slot 246 when the crossbar is in the horizontal position to couple the rear pivoting crossbar 222 to the crossbar latch pin 232. The crossbar latch 240 can also be fixed to a crossbar storage latch pin 234.

When a user slides the latch button 242 towards the pivoting pin 238, the latch catch 244 moves with the latch button 242 towards the pivoting pin 238 into an unlocked position that opens the latch slot 246 so that the rear pivoting crossbar 222 can be slidably detached from one of the crossbar latch pin 232 or the crossbar storage latch pin 234. The latch button 242 and latch catch 244 is biased to the horizontal position with a spring (not shown).

The crossbar latch 240 allows the rear pivoting crossbar 222 to detachably couple to the crossbar latch pin 232 when the rear pivoting crossbar 222 is in the horizontal safe position. The crossbar latch 240 also allows the rear pivoting crossbar 222 to detach from the crossbar storage latch pin 234 when the rear pivoting crossbar 222 moves to the entry position. In the horizontal safe position, the rear pivoting crossbar 222 extends horizontally between the pivoting pin 238 located on the right rear leg 228 to the crossbar latch pin 232 located on the left rear leg 226. In the horizontal safe position, the rear pivoting crossbar 222 prevents a user standing on the platform unit 216 from falling backwards and off the foldable step stool 210 as shown in FIG. 7. In the entry position, the rear pivoting crossbar 222 is in parallel alignment with the right rear leg 228, and allows a user to step on to or step off the platform unit 216.

The latch catch 244 moves from a normally extended position associated with the locked position of the crossbar latch 240, shown in FIG. 8, to a retracted position associated with the unlocked position of the crossbar latch 240, shown in FIG. 9. In the extended position, the latch catch 244 extends over the opening 245 to block movement of the crossbar 222 from the horizontal safe position to the entry position. In the retracted position, the latch catch 244 is moved out of the way and allows the crossbar 222 to be lifted up and away from the latch pin 234.

In illustrative embodiments of the present disclosure, a step stool 10 may include a top platform unit 16, a u-shaped handle rail 52 supported over the top platform unit 16 having a free side at free ends of the u-shaped handle rail 52, and a crossbar 22 that pivots from a horizontal position in which the crossbar 22 cooperates with the u-shape handle rail 52 to surround a user space above the top platform unit 16 to an entry position in which the crossbar 22 extends downwardly so as to open the free side of the u-shape handle rail 52 for a user to enter and exit the user space. The step stool 10 may further include a crossbar latch 40 coupled to the crossbar 22, the crossbar latch 40 being reconfigurable from a locked position arranged to block movement of the crossbar 22 away from the horizontal position to an unlocked position arranged to allow movement away from the horizontal position toward the entry position.

In some embodiments, the crossbar latch 40 may include a latch slot 46 arranged to receive a crossbar latch pin 32 when the crossbar 22 is in the horizontal position and a latch catch 44 arranged to block removal of the crossbar latch pin 32 from the latch slot 46 when the crossbar latch 40 is in the locked position. The latch catch 44 may be movable along a linear path relative to the crossbar 22 from an extended position arranged to block removal of the crossbar latch pin 32 from the latch slot 46 to a retracted position arranged to allow removal of the crossbar latch pin 32 from the latch slot 46.

In some embodiments, the latch slot 46 may form a downwardly-opening space that receives a crossbar latch pin 32 when the crossbar 22 is in the horizontal position and the latch catch 44 may extend under the crossbar latch pin 32 when in the extended position so as to establish the locked position of the crossbar latch 40. A bias member 35 may urge the latch catch 44 toward the extended position.

In some embodiments, the crossbar latch 40 may further include a housing 90, and the housing 90 may include a body 92 shaped to form a bar-receiving channel 95 that receives a portion of the crossbar 22 and a fixation plate 94 coupled to the body 92 and shaped to close the bar-receiving channel 95 trapping the crossbar 22 in the housing 90. The housing 90 may be coupled to a portion of the crossbar 22 spaced apart from a free, distal end of the crossbar 22. The housing 90 may be located along the crossbar 22 between the latch slot 46 and a proximal end of the crossbar 22 at which the crossbar 22 is mounted for movement relative to the u-shape handle rail 52.

In some embodiments, the crossbar latch 40 may include a latch button 42 that cooperates with the latch catch 44 to provide a one-piece, monolithic keeper component 95. The latch catch 44 may extend out of the housing 90 when in the extended position and may be retracted, at least in part, into the housing 90 when in the retracted position.

In some embodiments, the step stool 10 may further include a first rear leg 28 and a second rear leg 26, wherein the crossbar 22 is coupled to the first rear leg 28 to pivot from the horizontal position to the entry position, and wherein the latch pin 32 protrudes from the second rear leg 26.

In illustrative embodiments of the present disclosure, a step stool 10 may include a front frame 50 including a first front leg 56 and a second front leg 58, and a rear frame 20 including a first rear leg 28, a second rear leg 26, and a crossbar 22 with a proximal end coupled to the first rear leg 28 for pivotable motion from a horizontal position in which the crossbar 22 extends from the first rear leg 28 to the second rear leg 26 to an entry position in which the crossbar 22 is separated from the second rear leg 26 and extends downwardly along the first rear leg 28. The step stool 10 may further include a crossbar latch 40 coupled to the crossbar 22, the crossbar latch 40 being reconfigurable from a locked position arranged to block movement of the crossbar 22 away from the horizontal position to an unlocked position arranged to allow movement away from the horizontal position toward the entry position.

In some embodiments, the crossbar latch 40 may include a latch slot 46 arranged to receive a crossbar latch pin 32 when the crossbar 22 is in the horizontal position and a latch catch 44 arranged to block removal of the crossbar latch pin 32 from the latch slot 46 when the crossbar latch 40 is in the locked position. The latch catch 44 may be movable along a linear path relative to the crossbar 22 from an extended position arranged to block removal of the crossbar latch pin 32 from the latch slot 46 to a retracted position arranged to allow removal of the crossbar latch pin 32 from the latch slot 46.

In some embodiments, the latch slot 46 may form a downwardly-opening space that receives a crossbar latch pin 32 when the crossbar 22 is in the horizontal position and the latch catch 44 may extend under the crossbar latch pin 32 when in the extended position so as to establish the locked position of the crossbar latch 40.

In some embodiments, the crossbar latch 40 may further include a housing 90 and the latch catch 44 may be mounted for movement into and out of the housing 90. The housing 90 may include a body 92 shaped to form a bar-receiving channel 95 that receives a portion of the crossbar 22 and a fixation plate 94 coupled to the body 92 and shaped to close the bar-receiving channel 95 trapping the crossbar 22 in the housing 90. The housing 90 may be coupled to a portion of the crossbar 22 spaced apart from a free, distal end of the crossbar 22. The housing 90 may be located along the crossbar 22 between the latch slot 46 and a proximal end of the crossbar 22 at which the crossbar 22 is mounted for movement.

In some embodiments, the step stool 10 may further include a u-shape handle rail 52. The first front leg 56 and the second front leg 58 may be coupled to the u-shape handle rail 52 for rotation relative to the u-shape handle rail 52 at a first location near the closed end of the u-shape. The first rear leg 28 and the second rear leg 26 may be coupled to the u-shape handle rail 52 for rotation relative to the u-shape handle rail 52 at a second location near the free side of the u-shape. The crossbar 22, when in the horizontal position, may cooperate with the u-shape handle rail 52 to surround a user space and, when in the entry position, may extend downwardly along the first rear leg 28 so as to open the free side of the u-shape handle rail 52.

1. A step stool comprising
a top platform unit,
a u-shaped handle rail supported over the top platform unit having a free side at free ends of the u-shaped handle, and
a crossbar that pivots from a horizontal position in which the crossbar cooperates with the u-shape handle to surround a space above the top platform unit to an entry position in which the crossbar extends downwardly so as to open the free side of the u-shape handle for a user to enter and exit the user space, and
a crossbar latch coupled to the crossbar, the crossbar latch being reconfigurable from a locked position arranged to block movement of the crossbar away from the horizontal position to an unlocked position arranged to allow movement away from the horizontal position toward the entry position.

2. The step stool of claim 1, wherein the crossbar latch includes a latch slot arranged to receive a crossbar latch pin when the crossbar is in the horizontal position and a latch catch arranged to block removal of the crossbar latch pin from the latch slot when the crossbar latch is in the locked position.

3. The step stool of claim 2, wherein the latch catch is movable along a linear path relative to the crossbar from an extended position arranged to block removal of the crossbar latch pin from the latch slot to a retracted position arranged to allow removal of the crossbar latch pin from the latch slot.

4. The step stool of claim 3, wherein the latch slot forms a downwardly-opening space that receives a crossbar latch pin when the crossbar is in the horizontal position and the latch catch extends under the crossbar latch pin when in the extended position so as to establish the locked position of the crossbar latch.

5. The step stool of claim 3, wherein a bias member urges the latch catch toward the extended position.

6. The step stool of claim 3, wherein the crossbar latch further includes a housing, and wherein the housing includes a body shaped to form a bar-receiving channel that receives a portion of the crossbar and a fixation plate coupled to the body and shaped to close the bar-receiving channel trapping the crossbar in the housing.

7. The step stool of claim 6, wherein the housing is coupled to a portion of the crossbar spaced apart from a free, distal end of the crossbar.

8. The step stool of claim 7, wherein the housing is located along the crossbar between the latch slot and a proximal end of the crossbar at which the crossbar is mounted for movement relative to the u-shape handle rail.

9. The step stool of claim 6, wherein the crossbar latch includes a latch button that cooperates with the latch catch to provide a one-piece, monolithic keeper component.

10. The step stool of claim 9, wherein the latch catch extends out of the housing when in the extended position and is retracted, at least in part, into the housing when in the retracted position.

11. The step stool of claim 8, further comprising a first rear leg and a second rear leg, wherein the crossbar is coupled to the first rear leg to pivot from the horizontal position to the entry position, and wherein the latch pin protrudes from the second rear leg.

12. A step stool comprising
a front frame including a first front leg and a second front leg,
a rear frame including a first rear leg, a second rear leg, and a crossbar with a proximal end coupled to the first rear leg for pivotable motion from (i) a horizontal position in which the crossbar extends from the first rear leg to the second rear leg to (ii) a entry position in which the crossbar is separated from the second rear leg and extends downwardly along the first rear leg, and
a crossbar latch coupled to the crossbar, the crossbar latch being reconfigurable from a locked position arranged to block movement of the crossbar away from the horizontal position to an unlocked position arranged to allow movement away from the horizontal position toward the entry position.

13. The step stool of claim 12, wherein the crossbar latch includes a latch slot arranged to receive a crossbar latch pin when the crossbar is in the horizontal position and a latch catch arranged to block removal of the crossbar latch pin from the latch slot when the crossbar latch is in the locked position.

14. The step stool of claim 13, wherein the latch catch is movable along a linear path relative to the crossbar from an extended position arranged to block removal of the crossbar latch pin from the latch slot to a retracted position arranged to allow removal of the crossbar latch pin from the latch slot.

15. The step stool of claim 13, wherein the latch slot forms a downwardly-opening space that receives a crossbar latch pin when the crossbar is in the horizontal position and the latch catch extends under the crossbar latch pin when in the extended position so as to establish the locked position of the crossbar latch.

16. The step stool of claim 13, wherein the crossbar latch further includes a housing and the latch catch is mounted for movement into and out of the housing.

17. The step stool of claim 16, wherein the housing includes a body shaped to form a bar-receiving channel that receives a portion of the crossbar and a fixation plate coupled to the body and shaped to close the bar-receiving channel trapping the crossbar in the housing.

18. The step stool of claim 16, wherein the housing is coupled to a portion of the crossbar spaced apart from a free, distal end of the crossbar.

19. The step stool of claim 18, wherein the housing is located along the crossbar between the latch slot and a proximal end of the crossbar at which the crossbar is mounted for movement.

20. The step stool of claim 18, further comprising a u-shape handle rail,
wherein the first front and the second front legs are coupled to the u-shape handle rail for rotation relative to the u-shape handle rail at a first location near the closed end of the u-shape,
wherein the first rear and the second rear legs are coupled to the u-shape handle rail for rotation relative to the u-shape handle rail at a second location near the free side of the u-shape, and
wherein the cross bar, when in the horizontal position, cooperates with the u-shape handle to surround a user space and, when in the entry position, extends downwardly along the first rear leg so as to open the free side of the u-shape handle rail.
